(19) United States
(12) Patent Application Publication
(10) Pub. No.: US 2023/0311078 A1
(43) Pub. Date: Oct. 5, 2023

(54) BEVERAGE CARBONATOR

(71) Applicant: Jahn GmbH Umform- und Zerspanungstechnik, Tambach-Dietharz (DE)

(72) Inventors: Andreas JAHN, Tambach-Dietharz (DE); Rico ABE, Fambach (DE); Tobias ORTLEPP, Floh-Seligenthal (DE); Alexander GLÄSER, Schmalkalden O.T Asbach (DE); Harald STEHR, Georgenthal (DE)

(21) Appl. No.: 18/193,296

(22) Filed: Mar. 30, 2023

(30) Foreign Application Priority Data
Mar. 31, 2022 (DE) 10 2022 107 693.8

(51) Int. Cl. B01F 23/2361; B01F 23/237

(52) U.S. Cl. CPC B01F 23/23611; B01F 23/237621

(57) ABSTRACT

The invention relates to a beverage carbonator (1) having a basic unit (3), wherein the basic unit (3) comprises: a plurality of pressure container receptacles (4) for receiving a corresponding number of pressure containers (5), and a beverage container receptacle (6) for receiving a beverage container (7).

### CROSS-REFERENCE TO RELATED APPLICATION

This application claims priority to German application no. DE 10 2022 107 693.8 filed on Mar. 31, 2022, which is hereby incorporated by reference in its entirety.

### FIELD OF INVENTION

The invention relates to a beverage carbonator.

### BACKGROUND

Beverage carbonators, also known as water carbonators or drinking water carbonators, are generally known in the art. They have a basic unit in which a gas cartridge filled with carbon dioxide and a bottle filled with water are inserted. By actuating an actuating unit on the basic unit, the carbon dioxide is introduced into the bottle filled with water, causing the water to bubble.

### SUMMARY

The object of the invention is to provide a beverage carbonator that is improved compared to the prior art.

The object is achieved according to the invention by a beverage carbonator having the features of claim 1.

Advantageous embodiments of the invention are the subject of the subclaims.

A beverage carbonator according to the invention, also referred to as a water carbonator or drinking water carbonator, has a basic unit. The basic unit has a plurality of pressure container receptacles for receiving a corresponding number of pressure containers and a beverage container receptacle for receiving a beverage container. In one possible embodiment, the basic unit also has a number of actuating units corresponding to the plurality of pressure container receptacles, each pressure container receptacle being assigned its own actuating unit. The respective actuating unit is provided for opening a fluidic connection between the pressure container arranged in the pressure container receptacle assigned to it and the beverage container arranged in the beverage container receptacle. Alternatively, for example, one actuating unit can be provided for all pressure containers arranged in the pressure container receptacles. In this case, for example, each pressure container receptacle is assigned a specific actuation of this one actuation unit. The actuation unit is then provided, in particular by the respective specific actuation, for opening a fluidic connection between the pressure container arranged in the respective pressure container receptacle and the beverage container arranged in the beverage container receptacle.

For example, the beverage carbonator has at least or exactly two or at least or exactly three or at least or exactly four pressure container receptacles. In particular, it then also has a corresponding number of actuation units or the one actuation unit with a corresponding number of specific actuation options. The respective pressure container is also referred to as a pressurized gas container, gas cartridge, cylinder or gas cylinder. The beverage container is in particular a bottle. If a pressure container filled with gas, in particular with carbon dioxide, and a beverage container filled with a beverage, in particular water, in particular drinking water, are arranged in the respective receptacle of the basic unit, the beverage in the beverage container can be bubbled by actuating the actuating unit assigned to the pressure container or by specifically actuating the one actuating unit provided for all pressure containers on the basic unit, as a result of which the fluidic connection between this pressure container and the beverage container is opened, since the gas then flows from the pressure container into the beverage container.

The beverage carbonator according to the invention is provided in particular for pressure containers with different fillings, in particular for pressure containers which, in addition to the gas, in particular carbon dioxide, are also filled with a flavor, whereby the beverage is simultaneously flavored during bubbling. That is, by actuating the actuating unit associated with the respective pressure container, or by specifically actuating the one actuating unit provided for all pressure containers on the basic unit, thereby opening the fluidic connection between this pressure container and the beverage container, the beverage in the beverage container is bubbled and flavored, since the gas and the flavor then flow from the pressure container into the beverage container. The plurality of pressure container receptacles allows, for example, pressure containers with different flavors and, for example, a pressure container without flavor, i.e. with gas only, to be arranged in the beverage carbonator, so that a user, in particular in the beverage carbonator which requires only a relatively small footprint, has a corresponding selection available without first having to exchange a pressure container which is already arranged in the beverage carbonator for another one for this purpose.

In one possible embodiment, the respective pressure container receptacle is pivotably coupled to the basic unit. As a result, the respective pressure container can be to swiveled laterally, in particular at an angle, out of the basic unit for removal, and a new pressure container can be inserted laterally into the pressure container receptacle and then swiveled into the basic unit. This facilitates the replacement of the respective pressure container.

In one possible embodiment, the basic unit has a protective screen for at least partially or completely closing a receiving space for the beverage container. This is useful or mandatory, for example, for glass beverage containers for safety reasons. The protective screen is, for example, movably, for example pivotably, attached to the basic unit to enable opening of the receiving space for insertion and removal of the beverage container. If the basic unit has this protective screen, it is provided in particular that bubbling is possible only when the protective screen is in a closed position, i.e. the receiving space is closed at least in sections or completely by the protective screen. For example, it is thus provided that the respective actuating unit or the one actuating unit provided for all pressure containers can only be actuated when the protective screen is in the closed position.

In an alternative embodiment, no such protective screen is provided. This embodiment is provided, for example, for plastic beverage containers for which such a protective screen is not required.

In one possible embodiment, the basic unit has a base and an upper part which are connected to one another via at least one support element. The pressure container receptacles and the beverage container receptacle are each formed or arranged in the upper part. For example, the actuating units or the one actuating unit are also formed or arranged in the upper part.

In one possible embodiment, the basic unit has at least one cladding part for closing a receiving space for the pressure containers. In order to clarify for a user an assignment of the actuation units or the respective specific actuation of the one actuation unit to the pressure containers, for example, a corresponding labeling or other indication design is provided on the actuation units or on the one actuation unit.

In one possible embodiment, the beverage container receptacle has a thread for screwing in a corresponding beverage container connection thread arranged or formed to on the beverage container. It is thus formed as a screw-in connection for the beverage container. The beverage container connection thread is arranged or formed in particular in an upper region of the beverage container, for example on a bottle neck of the beverage container formed as a bottle. The thread of the beverage container receptacle is, for example, an internal thread and the corresponding beverage container connection thread is an external thread. The threaded solution enables secure attachment of the beverage container to the beverage carbonator for bubbling the beverage.

In an alternative possible embodiment, a bayonet fitting is provided for receiving the beverage container. The beverage container receptacle thus has a part of this bayonet fitting for connection to a corresponding part of the bayonet fitting which is arranged or formed on the beverage container, in particular in the upper region of the beverage container, for example on the bottle neck of the beverage container formed as a bottle. This bayonet fitting solution also enables the beverage container to be securely fastened to the beverage carbonator for bubbling the beverage.

In an alternative possible embodiment, a snap-in connection is provided for receiving the beverage container. The beverage container receptacle thus has a part of this snap-in connection for connection to a corresponding part of the snap-in connection which is arranged or formed on the beverage container, in particular in the upper region of the beverage container, for example on the bottle neck of the beverage container designed as a bottle. This snap-in connection solution also enables the beverage container to be securely fastened to the beverage carbonator for bubbling the beverage.

In one possible embodiment, it is provided that the respective pressure container receptacle has a thread for screwing in a corresponding pressure container connection thread, which is arranged or formed on the respective pressure container. In an alternative possible embodiment, it is provided that the respective pressure container receptacle has a snap-in receptacle for inserting and snapping in a corresponding pressure container connection, which is formed or arranged on the respective pressure container. For example, the respective pressure container receptacle and the respective pressure container have corresponding snap-in connecting parts for this purpose. Both variants ensure stable accommodation of the respective pressure container. Likewise, to there may be pressure container receptacles of both embodiments be provided on the beverage carbonator, for example in order to be able to use pressure containers with these different pressure container connections in the beverage carbonator.

In one possible embodiment, the beverage carbonator also has the beverage container. In particular, it is provided that the beverage container is arranged in the beverage container receptacle.

In a possible embodiment, the beverage carbonator also comprises at least one pressure container or a plurality of pressure containers. In particular, a number of the pressure containers corresponds to the plurality of pressure container receptacles. In particular, one pressure container is arranged in each pressure container receptacle.

The respective pressure container, which is in particular in the form of a gas cartridge, can, for example, be a conventional pressure container, i.e. one that is already known in the art and, in particular, is commercially available. Alternatively, it can also be provided that a respective pressure container not yet in the art is used.

As already mentioned above, the respective pressure container can also be filled with a flavor in addition to the gas, in particular carbon dioxide, for example, in order to also flavor the beverage at the same time through the bubbling. In this respect, several different flavors are available, for example, in the beverage carbonator with several pressure containers described here. For example, it can be provided that an outer side of the respective pressure container has, in its entirety or in sections, at least one colored marking which is arranged or formed on the outer side of the respective pressure container. This colored marking is provided, for example, for identifying the flavor that is filled in the respective pressure container or for identifying that no flavor, but only the gas, is filled in the respective pressure container.

The respective pressure container has, for example, a container body with a container bottom arranged at a lower end and, in particular, formed integrally and/or in one piece with the container body. At an upper end and thus opposite the container bottom, the container body has an end region which is in particular formed integrally and/or in one piece with the container body. The end region has a container opening in and/or on which a valve is arranged or can be arranged.

### BRIEF DESCRIPTION OF THE DRAWINGS

Exemplary embodiments of the invention are explained in more detail below with reference to drawings.

FIG. 1 is a schematic rear view of a beverage carbonator,

FIG. 2 is a schematic side view of the beverage carbonator,

FIG. 3 is a schematic perspective view of the beverage carbonator without the cladding, and

FIG. 4 is a schematic perspective view of the beverage carbonator.

Corresponding parts are marked with the same reference signs in all figures.

### DETAILED DESCRIPTION OF SPECIFIC EMBODIMENTS

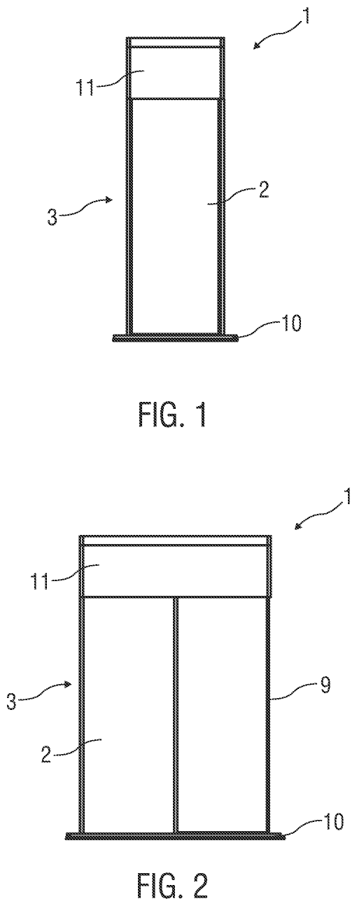

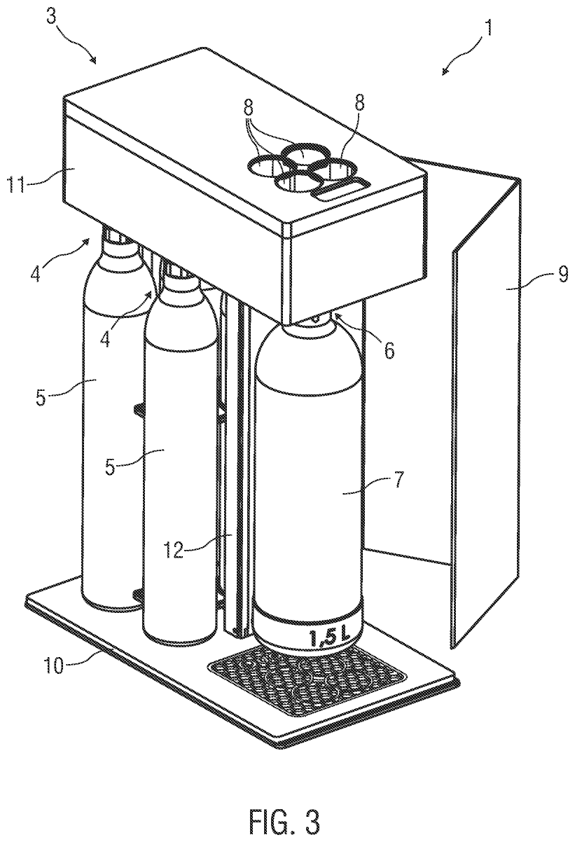

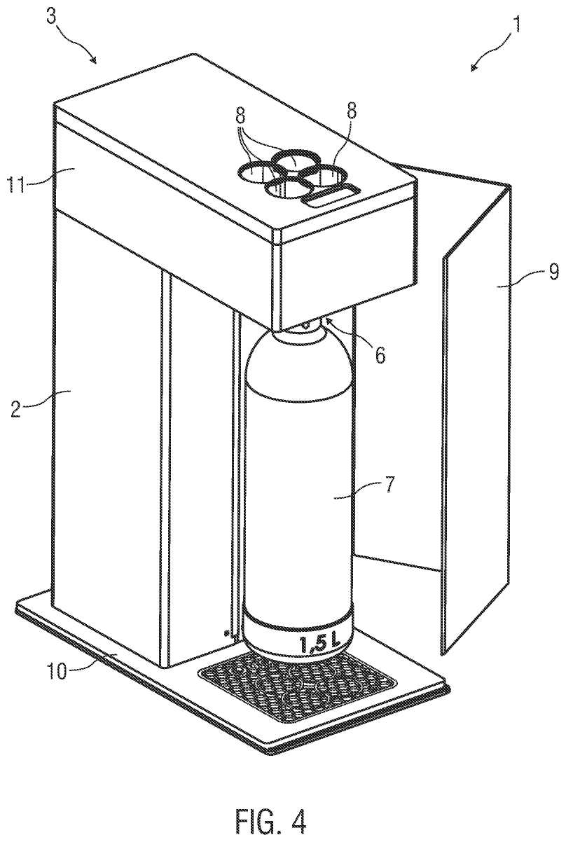

FIGS. 1 to 4 show a beverage carbonator 1, with FIG. 1 showing the beverage carbonator 1 in a rear view and FIG. 2 in a side view. FIG. 3 shows a perspective view of the beverage carbonator 1 without cladding part 2 and FIG. 4 shows a perspective view of the beverage carbonator 1 with cladding part 2.

The beverage carbonator 1, also referred to as a water carbonator or drinking water carbonator, has a basic unit 3. The basic unit 3 has a plurality of pressure container receptacles 4 for receiving a corresponding number of pressure containers 5, for example at least two or at least three pressure container receptacles 4 for receiving a corresponding number of pressure containers 5. In the example shown, the basic unit 3 has four pressure container receptacles 4 for receiving four pressure containers 5.

Furthermore, the basic unit 3 has a beverage container receptacle 6 for receiving a beverage container 7.

In addition, in the example shown, the basic unit 3 has a number of actuating units 8 to corresponding to the plurality of pressure container receptacles 4, thus four actuating units 8 in the example shown, each pressure container receptacle 4 being assigned its own actuating unit 8, in particular comprising a respective actuating button. The respective actuating unit 8 is provided for opening a fluidic connection between the pressure container 5 arranged in the pressure container receptacle 4 associated therewith and the beverage container 7 arranged in the beverage container receptacle 6.

The respective pressure container 5 is also referred to as a pressurized gas container, gas cartridge, cylinder or gas cylinder. The beverage container 7 is in particular a bottle. If a pressure container 5 filled with gas, in particular with carbon dioxide, and a beverage container 7 filled with a beverage, in particular water, in particular drinking water, are arranged in the respective receptacle of the basic unit 3, the beverage in the beverage container 7 can be bubbled by actuating the actuating unit 8 assigned to the pressure container 5 on the basic unit 3, as a result of which the fluidic connection between this pressure container 5 and the beverage container 7 is opened, since the gas then flows from the pressure container 5 into the beverage container 7.

The beverage carbonator 1 is provided in particular for pressure containers 5 with different fillings, in particular for pressure containers 5 which are also filled with a flavor in addition to the gas, in particular carbon dioxide, as a result of which the beverage is simultaneously flavored during bubbling. That is, by actuating the actuating unit 8 associated with the respective pressure container 5 on the basic unit 3, which opens the fluidic connection between this pressure container 5 and the beverage container 7, the beverage in the beverage container 7 is bubbled and flavored, since the gas and the flavor then flow from the pressure container 5 into the beverage container 7. Due to the plurality of pressure container receptacles 4, for example, pressure containers 5 with different flavors and, for example, a pressure container 5 without flavor, i.e., with gas only, can be arranged in the beverage carbonator 1, so that a user has a corresponding selection available without having to first exchange a pressure container 5 already arranged in the beverage carbonator 1 for another one for this purpose.

The respective pressure container receptacle 4 is coupled to the basic unit 3 in particular in a pivotable manner. As a result, the respective pressure container 5 can be swiveled laterally, in particular at an angle, out of the basic unit 3 for removal, and a new pressure container 5 can be inserted laterally into the pressure container receptacle 4 and then swiveled into the basic unit 3. This facilitates the replacement of the respective pressure container 5.

In the embodiment shown, the basic unit 3 has a protective screen 9 for at least partially or completely closing a receiving space for the beverage container 7. This is useful or mandatory, for example, for beverage containers 7 made of glass for safety reasons. The protective screen 9 is, as shown in FIGS. 3 and 4, for example movably, for example pivotably, attached to the basic unit 3 to enable the receiving space to be opened for insertion and removal of the beverage container 7. In particular, it is provided that bubbling is only possible when the protective screen 9 is in a closed position, i.e. the receiving space is at least partially or completely closed by the protective screen 9. For example, it is thus provided that the respective actuating unit 8 can only be actuated when the protective screen 9 is in the closed position.

In an alternative embodiment not shown, no such protective screen 9 is provided. This embodiment is provided, for example, for plastic beverage containers 7 for which such a protective screen 9 is not required.

The basic unit 3 has a base 10 and an upper part 11, which are connected to each other via at least one support element 12. The pressure container receptacles 4, the actuating units 8 and the beverage container receptacle 6 are each formed or arranged in the upper part 11.

In the embodiment shown, the basic unit 3 has the cladding part 2 already mentioned above for closing a receiving space for the pressure containers 5.

In the illustrated embodiment, the beverage carbonator 1 also has the beverage container 7, which is already arranged here in the beverage container receptacle 6.

In the embodiment shown, the beverage carbonator 1 also has the four pressure containers 5, which are already arranged here in the respective pressure container receptacle 4.

### LIST OF REFERENCES

1 beverage carbonator
2 cladding part
3 basic unit
4 pressure container receptacle
pressure container
6 beverage container receptacle
7 beverage container
8 actuating unit
9 protective screen
10 base
11 upper part
12 support element

What is claimed is:

1. A beverage carbonator having a basic unit, the basic unit comprising:
a plurality of pressure container receptacles for receiving a corresponding number of pressure containers, and
a beverage container receptacle for receiving a beverage container.

2. The beverage carbonator according to claim 1,
wherein the basic unit has a number of actuating units corresponding to the plurality of pressure container receptacles, wherein each pressure container receptacle is assigned its own actuating unit and wherein the respective actuating unit is provided for opening a fluidic connection between the pressure container arranged in the pressure container receptacle assigned thereto and the beverage container arranged in the beverage container receptacle.

3. The beverage carbonator according to claim 1,
wherein at least two pressure container receptacles are provided.

4. The beverage carbonator according to claim 1,
wherein at least three pressure container receptacles are provided.

5. The beverage carbonator according to claim 1,
wherein at least four pressure container receptacles are provided.

6. The beverage carbonator according to claim 1,
wherein the respective pressure container receptacle is pivotably coupled to the basic unit.

7. The beverage carbonator according to claim 1,
wherein the basic unit has a protective screen for at least partially closing a receiving space for the beverage container.

8. The beverage carbonator according to claim 1,
wherein the basic unit has a base and an upper part, which are connected to one another via at least one support element.

9. The beverage carbonator according to claim 8,
wherein the pressure container receptacles and the beverage container receptacle are each formed or arranged in the upper part.

10. The beverage carbonator according to claim 1,
wherein the basic unit comprises at least one cladding part for closing a receiving space for the pressure containers.

11. The beverage carbonator according to claim 1,
wherein the beverage container receptacle comprises a thread for screwing in a corresponding beverage container connection thread arranged or formed on the beverage container.

12. The beverage carbonator according to claim 1,
wherein the respective pressure container receptacle has a thread for screwing in a corresponding pressure container connection thread, which is arranged or formed on the pressure container.

13. The beverage carbonator according to claim 1,
wherein the respective pressure container receptacle has a snap-in receptacle for engaging a corresponding pressure container connection thread which is formed or arranged on the pressure container.

14. The beverage carbonator according to claim 1,
wherein the beverage container is arranged in the beverage container receptacle.

15. The beverage carbonator according to claim 1,
wherein a respective pressure container is arranged in each pressure container receptacle.

16. The beverage carbonator according to claim 1,
wherein the basic unit has an actuating unit, wherein each pressure container receptacle is assigned a specific actuation of this one actuation unit, wherein the actuation unit is configured for opening a fluidic connection between the pressure container arranged in the respective pressure container receptacle and the beverage container arranged in the beverage container receptacle upon performance of the respective specific actuation.
